(19) United States
(12) Patent Application Publication
(10) Pub. No.: US 2025/0259074 A1
(43) Pub. Date: Aug. 14, 2025

(54) DEVICE AND METHOD FOR GENERATING A FIRST AGENT, IN PARTICULAR FOR AN INTERACTION BETWEEN THE FIRST AGENT AND A SECOND AGENT, AND DEVICE AND METHOD FOR TRAINING AT LEAST ONE MODEL FOR GENERATING THE FIRST AGENT

(71) Applicant: Robert Bosch GmbH, Stuttgart (DE)

(72) Inventor: Philipp Geiger, Karlsruhe (DE)

(21) Appl. No.: 19/037,717

(22) Filed: Jan. 27, 2025

(30) Foreign Application Priority Data
Feb. 9, 2024 (DE) 10 2024 201 220.3

(51) Int. Cl. G06N 3/092; G06N 3/042

(52) U.S. Cl. CPC G06N 3/092; G06N 3/042

(57) ABSTRACT

A device and a method for training at least one model or for generating a first agent, in particular for an interaction between the first agent and a second agent. A description of a behavior of the first agent, in particular in the interaction between the first agent and the second agent, is mapped onto a first representation using a first model; the first representation is mapped onto a second representation by means of a second model; the second representation is mapped onto an output variable for influencing the behavior of the first agent using a third model. The description is specified in natural language, in text form or audio form, or in formal language or in digital graphic form, wherein the behavior of the first agent, in particular in the interaction between the first agent and the second agent, is specified depending on the output variable.

### SUMMARY

A method for generating a first agent, in particular for interaction between the first agent and a second agent, provides that a description of a behavior of the first agent, in particular in the interaction between the first agent and the second agent, is mapped onto a first representation by means of a first model, which is designed to map the description onto the first representation, wherein the first representation is mapped onto a second representation by means of a second model, which is designed to map the first representation onto the second representation, wherein the second representation is mapped onto an output variable for influencing the behavior of the first agent by means of a third model, which is designed to map the second representation onto the output variable, wherein the description is specified in natural language, in particular in text form or audio form, or in formal language or in digital graphic form, wherein the behavior of the first agent, in particular in the interaction between the first agent and the second agent, is specified depending on the output variable. Each model can be a stochastic, probabilistic model or a deterministic model.

For example, an anomaly in the behavior of the second agent in the interaction between the first agent and the second agent is recognized depending on the interaction.

According to an example embodiment of the present invention, it may be provided that the output variable comprises a trajectory of the first agent and/or that the output variable comprises controller parameters for a controller of the first agent, wherein the behavior of the first agent is determined depending on a behavior of the controller in the first agent.

According to an example embodiment of the present invention, it may be provided that the first model comprises a pre-trained artificial neural network and/or the second model comprises a pre-trained artificial neural network and/or that the third model comprises a pre-trained artificial neural network.

According to an example embodiment of the present invention, the method for training at least one model for generating a first agent, in particular for an interaction between a first agent and a second agent, provides that a description of a behavior of the first agent, in particular in the interaction between the first agent and the second agent, is mapped onto a first representation by means of a first model, which is designed to map the description onto the first representation, wherein the first representation is mapped onto a second representation by means of a second model, which is designed to map the first representation onto the second representation, wherein the second representation is mapped onto an output variable by means of a third model, which is designed to map the second representation onto the output variable, wherein the description is specified in natural language or in formal language or in digital graphic form, wherein the description and a reference for the output variable are specified, wherein the reference characterizes a behavior of the first agent that is realistic in the real world and matches the description, and wherein the second model is trained depending on a difference between the output variable and the reference. This trains the second model to output variables that define a behavior of the first agent that is as physically realistic as possible in the real world and matches the description.

It may be provided that the first model comprises a pre-trained artificial neural network and/or that the third model comprises a pre-trained artificial neural network. This means that the training is based on models that are already available.

It may be provided that the first model and/or the third model remain unchanged during training. This means that the second model is trained specifically. This requires less training data than if the second model is trained together with the first model and/or the third model.

It may be provided that the reference comprises a trajectory of the first agent and/or controller parameters for a controller of the first agent.

According to an example embodiment of the present invention, a device for generating interactions or for training at least one model or for training a first agent for an interaction between the first agent and a second agent comprises at least one processor and at least one memory, wherein the at least one processor is designed to execute instructions that, when executed by the at least one processor, cause the device to perform the method, wherein the at least one memory stores the instructions.

According to an example embodiment of the present invention, a data structure comprises at least one data field for a description of a behavior of a first agent, in particular in the interaction between the first agent and a second agent, in natural language or in formal language, wherein the data structure comprises at least one data field for a first representation of the description, wherein the data structure comprises at least one data field for a second representation of the description, wherein the data structure comprises at least one data field for an output variable for influencing the behavior of the first agent.

It may be provided that the data structure comprises at least one data field for a first model, which is designed to map the description onto the first representation, wherein the data structure comprises at least one data field for a second model, which is designed to map the first representation onto the second representation, and/or wherein the data structure comprises at least one data field for a third model, which is designed to map the second representation onto the output variable.

It is possible to provide a computer program that comprises instructions that are executable by a computer and that, when executed by the computer, cause the method to run on the computer.

Further advantageous embodiments of the present invention can be found in the following description and the figures.

### BRIEF DESCRIPTION OF THE DRAWINGS

FIG. 1 is a schematic representation of a device for machine learning or for generating a behavior of a first agent, according to an example embodiment of the present invention.

FIG. 2 is a schematic representation of models for machine learning or for generating the behavior of the first agent, according to an example embodiment of the present invention.

FIG. 3 is a schematic representation of an exemplary interaction, according to an example embodiment of the present invention.

FIG. 4 is a flow chart with steps of the method for generating a behavior of the first agent, according to an example embodiment of the present invention.

FIG. 5 is a flow chart with steps of the method for machine learning, according to an example embodiment of the present invention.

### DETAILED DESCRIPTION OF EXAMPLE EMBODIMENTS

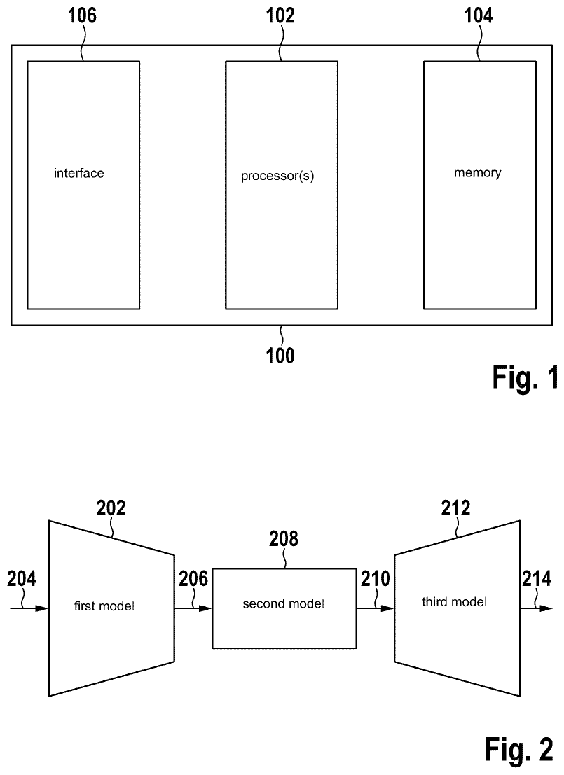

FIG. 1 schematically shows a device 100 for machine learning or for generating a behavior of a first agent, in particular in an interaction between the first agent and a second agent.

The device 100 comprises at least one processor 102 and at least one memory 104.

The at least one processor 102 is designed to execute instructions that, when executed by the at least one processor 102, cause the device 100 to perform a below-described method for machine learning or for generating the behavior.

The at least one memory 104 stores the instructions. The at least one memory 104 comprises, for example, a non-volatile memory. The at least one memory 104 comprises, for example, a volatile memory.

In the example, the device 100 comprises an interface 106. The interface 106 is designed, for example, to receive a description of the behavior.

The interface 106 may be designed to capture the description in text form, in audio form, or in digital graphic form.

The interface 106 may be designed to request the description by output in text form or audio form. The device 100 is designed, for example, to request and capture the description in a dialog with a user.

For example, the device 100 is designed to automatically query information required for the description and to add it to the description. The device 100 is designed, for example, to generate the description when the device 100 recognizes that the information required for the description has been captured.

FIG. 2 schematically shows models for machine learning or for generating the behavior.

In the example, a first model 202 is designed to map an input variable 204 of the first model 202 onto an output variable 206 of the first model 202. The first model 202 is, for example, an encoder, or a sequential and/or autoregressive encoder, or a transformer architecture.

In the example, a second model 208 is designed to map the output variable 206 of the first model 202 onto an output variable 210 of the second model 208. The second model 208 is, for example, a translator, which translates the output variable 206 of the first model 202 into the output variable 210 of the second model 208, i.e., an input variable for the third model 212.

In the example, a third model 212 is designed to map the output variable 210 of the second model 208 onto an output variable 214 of the third model 212. The third model 212 is, for example, a decoder.

In the example, the input variable 204 of the first model 202 comprises the description in natural language or formal language or in digital graphic form. In the example, the output variable 206 of the first model 202 comprises a first representation. The first representation is, for example, a first embedding or a first sequence of tokens. In the example, the output variable 210 of the second model 208 comprises a second representation. The second representation is, for example, a second embedding or a second sequence of tokens. The output variable 214 of the third model 212 defines the behavior.

The first model 202 comprises, for example, an artificial neural network. The second model 208 comprises, for example, an artificial neural network. The third model 212 comprises, for example, an artificial neural network.

The device 100 comprises, for example, the models. The device 100 is designed, for example, to receive the description via the interface 106 and to determine the output variable for the description by means of the models.

It may be provided that the device 100 is designed to carry out tests. The device 100 is designed, for example, during a test to check a behavior of the second agent in the interaction with the first agent depending on the interaction. The device 106 is designed, for example, during the test to recognize an anomaly in the interaction and, as a result of the test, to output the presence of the anomaly via the interface 106 or to output via the interface 106 that no anomaly is recognized during the test.

The interaction is not limited to an agent to be checked during the test or to an agent that can be moved synthetically in the interaction. Multiple agents that are to be tested with the interaction during the test may be provided. Multiple agents that can move synthetically in the interaction during the test may be provided. The description describes, for example, the behavior of the corresponding agent to be moved synthetically. The behavior of the corresponding synthetically movable agent is defined, for example, by the output variable 214.

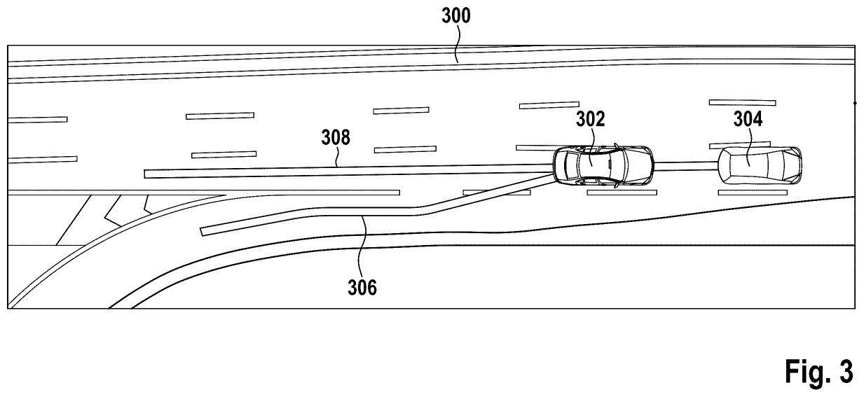

FIG. 3 depicts, as an example of the interaction, an exemplary scenario 300 with a first vehicle 302, as an example of a first agent, and a second vehicle 304, as an example of a second agent. The scenario 300 includes a trajectory 306 of the first vehicle 302 and a trajectory 308 of the second vehicle 304.

The scenario 300 is depicted for the following exemplary description in natural language:

Freeway entrance ramp scenario, with a first vehicle moving on the freeway entrance ramp having to merge after a second vehicle moving on the freeway.

In the example, the first vehicle 302 comprises at least one sensor for detecting sensor data that characterize an environment of the vehicle 302.

In the example, the first vehicle 302 comprises a controller for controlling the behavior of the first vehicle 302 depending on the sensor data. The controller is parameterized, for example, by controller parameters.

During the test, for example, the second vehicle 304 is checked in the interaction with the first vehicle 302.

The depiction of the scenario 300 represents the trajectory 306 as an exemplary description of the behavior of the first vehicle 302 in digital graphic form. The depiction is exemplary. The device 100 can be designed to use the scenario 300 in a formal language that can be processed automatically during the test, for example by a test bench or a simulation environment in which the test is performed.

It may be provided that the description provided as an input variable 204 of the first model 202 is supplemented by information in natural language on framework conditions. These framework conditions define, for example in natural language,
a geometry of the freeway,
weather conditions such as dry, windy, rain, snow, black ice, visibility conditions such as foggy, dark, bright,
traffic rules, such as speed limits, no passing.

The scenario 300 includes, for example, a description of a map that comprises the boundary conditions. The map is described, for example, in a formal language that can be processed automatically by the test bench or the simulation environment.

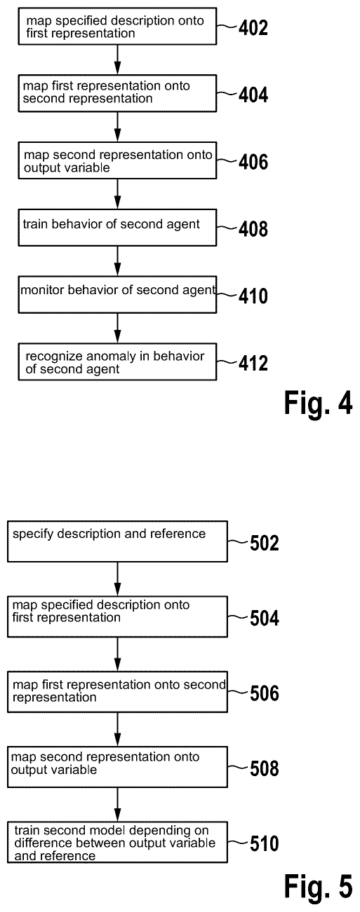

FIG. 4 shows a flow chart with steps of a method.

In one example, the agents are road users. The first agent is, for example, the first vehicle 302. The second agent is, for example, the second vehicle 304.

In a robotics example, the first agent is a robot and the second agent is a human model.

The method is based on a specified description.

The description is specified, for example, in natural language, in particular in text form or audio form, or in formal language, or in digital graphic form. A user inputs the description, for example in text form, or speaks the description in audio form. A user draws the description in digital graphic form, for example in the form of a sketch.

The description is requested, for example, by an output in text form or audio form. The description is requested and captured, for example, in a dialog with a user.

The information required for the description is, for example, automatically queried and added to the description.

For example, the description is generated only when it is recognized that the information required for the description has been captured.

For example, a description of an interaction that is rare in the real world is captured in particular by means of language. An example of a rare interaction is an interaction in which the second agent is an autonomous vehicle, wherein the first agent is another vehicle that, driving out of a parking space that is not visible to the autonomous vehicle, unexpectedly pulls in front of the autonomous vehicle. An example of a rare interaction is an interaction with an agent's aggressive driving behavior, e.g., when the agent merges into the traffic of other agents on a freeway. An example of a rare interaction is an interaction under an extreme weather condition in which the first agent and/or the second agent is located. An example of a rare interaction is an interaction under very rare environmental conditions, for example on a day when the first agent represents a human who is in costume, such as on Halloween or Mardi Gras. Rare in this context means that the interaction occurs very rarely in training data captured in the real world.

The method is based on the first model 202, the second model 208, and the third model 212. In the example, the first model 202, the second model 208, and the third model 212 are specified in the method. For example, each artificial neural network is pre-trained.

The first model 202 is, for example, a model that is pre-trained for text inputs and/or audio inputs and is designed to map the description in text form or in audio form onto the first representation. The use of the first model 202 pre-trained for this purpose makes higher data efficiency possible in comparison to a single model that is trained to map the description directly onto the output variable 214.

The behavior of the first agent is, for example, generated in a specific domain, e.g., transportation or robotics. The first model 202 and/or the third model 212 are, for example, pre-trained in a different domain or without content specialization to the domain in which the behavior of the agent is generated. The domain in which the first model 202 and/or the third model 212 are pre-trained is a different domain, for example a more general domain, than the domain in which the behavior of the first agent is generated.

The pre-trained first model 202 and/or the pre-trained third model 212 makes knowledge transfer possible, in particular from a domain in which the first model 202 or the third model 212 is pre-trained to the domain in which the first agent is generated. For example, each pre-trained model can comprise general knowledge about a behavior of the first agent. For example, a behavior of a pedestrian represented by the first agent can be better generated based on the general knowledge if the corresponding pre-trained model is pre-trained with more data that comprise human behavior.

During subsequent training of the corresponding pre-trained model to generate the first agent, less data with pedestrian behavior are then required to generate the behavior of the first agent relatively well, as would otherwise only be possible with more data with pedestrian behavior.

The method comprises a step 402.

In step 402, the specified description is mapped onto the first representation by means of the first model 202.

The method comprises a step 404.

In step 404, the first representation is mapped onto the second representation by means of the second model 208.

The method comprises a step 406.

In step 406, the second representation is mapped onto the output variable 214 by means of the third model 212.

The method may comprise further steps for training and/or testing the behavior of the second agent.

Steps 402 to 406 are repeated, for example, to generate training data comprising output variables 214 for training and/or testing the behavior of the second agent. For example, a plurality of output variables 214 is determined from a catalog of descriptions and added to the training data.

The catalog comprises, for example, a description of interactions in an area. An example of descriptions of an area is the operational design domain described in Koopman, P., Osyk, B., Weast, J. (2019); “Autonomous Vehicles Meet the Physical World: RSS, Variability, Uncertainty, and Proving Safety;” in: Romanovsky, A., Troubitsyna, E., Bitsch, F. (eds) Computer Safety, Reliability, and Security. SAFECOMP 2019. Lecture Notes in Computer Science(), vol. 11698. Springer, Cham. doi.org/10.1007/978-3-030-26601-1_17.

For example, the method for training comprises a step 408.

In step 408, a behavior of the second agent in the interaction between the first agent and the second agent is trained.

The behavior of the first agent is determined, for example, by the trajectory specified for the first agent in the scenario.

The first agent may comprise a controller designed to determine the behavior of the first agent depending on the scenario. The behavior of the first controller is determined, for example, by the controller in the first agent.

For example, the second agent is trained by means of reinforcement learning. For example, the second agent is rewarded if the second agent does not collide with the first agent, which is moving on the specified trajectory, and is not rewarded otherwise.

The second agent may comprise a sensor and a controller designed to determine the behavior of the second agent depending on information about the first agent measured by the sensor. The behavior of the second controller is determined, for example, by the controller in the second agent. For example, the controller of the second agent is trained by means of reinforcement learning.

For example, the method for testing comprises a step 410.

In step 410, the behavior of the second agent is monitored. It may be provided that the behavior of the first agent is monitored or that the behavior of the first agent generated by means of the models is used as a basis for testing.

The behavior of the first agent is determined, for example, by the trajectory or the controller in the first agent.

For example, the method for testing comprises a step 412.

In step 412, an anomaly in the behavior of the second agent is recognized depending on the interaction of the second agent with the first agent. For example, the anomaly in the behavior of the second agent is recognized depending on the interaction.

For example, the anomaly in the behavior of the second agent is recognized when the first agent collides with the second agent.

It may be provided that the method generates multiple agents including their interaction behavior with one another and toward potential third parties. It may be provided that, in a real-world test environment or in a simulation, the generated agents interact with one or more external agents in order to test how the external agents interact with the generated agents.

The test itself is performed, for example, in the real-world test environment or in the simulation in which the agents interact. Simulation is in particular preferable for tests that can lead to collisions, in order not to endanger human lives or to prevent the destruction of real-world agents.

For example, a description of a merging scenario in which two agents are driving with little space between them in the region of an entrance ramp on a freeway generates a behavior of two agents driving on the freeway according to the described merging scenario.

For example, an external agent which is controlled by an externally specified controller and whose behavior is thus not generated by means of the description is tested to see whether this external agent nevertheless merges without accidents.

Additionally, it may be provided that the test is performed for the domain in which the first agent is generated and for further descriptions specified by a user.

It may be provided that further tests are performed, for example with interactions that have been captured in the real world. It may be provided that the interactions captured in the real world are randomly selected from a set of specified interactions captured in the real world.

FIG. 5 shows a flow chart with steps of a method for training at least one of the models.

The method for training is based on the first model 202, the second model 208, and the third model 212. In the example, the first model 202 and the third model 212 are specified in the method for training at least one of the models. For example, the respective neural networks of the first model 202 and of the third model 212 are pre-trained.

Because of the information stored in pre-training and because of the density of information contained in language, the pre-trained models result in knowledge transfer and/or higher data efficiency in comparison to models learned only on the domain in which the first agent is generated.

The method for training at least one of the models is based on training data. In the example, the training data comprise training data points, each of which comprises a specified description and a reference assigned to the specified description. In addition, the method can be based on pre-trained models.

The method for training at least one of the models comprises a step 502.

In step 502, the description and the reference are specified from a training data point.

In step 504, for a training data point, the specified description is mapped onto the first representation by means of the first model 202.

The method for training at least one of the models comprises a step 506.

In step 506, for the training data point, the first representation is mapped onto the second representation by means of the second model 208.

The method for training at least one of the models comprises a step 508.

In step 508, for the training data point, the second representation is mapped onto the output variable 214 by means of the third model 212.

The reference comprises, for example, an output variable for a behavior that is realistic in the real world and matches the description. The output variable comprises, for example, a trajectory that defines the behavior of the first agent, a controller parameter for the controller of the first agent, and/or a map that defines boundary conditions for the behavior of the first agent.

In the example, steps 502 to 508 are performed for the training data points from the training data.

The method for training at least one of the models comprises a step 510.

In step 510, the second model 208 is trained depending on a difference between the output variable 214 and the reference.

In the example, the second model 208 is trained depending on an objective function that comprises the corresponding difference determined for the training data points. For example, the second model 208 is determined, by means of which an objective function that depends on a sum of the differences is as small as possible, in particular minimal.

For example, parameters of the neural network comprised by the second model 208 are determined depending on the differences by means of a gradient descent method.

In the example, the first model 202 and the third model 212 remain unchanged during the training of the second model 202. It may be provided that the first model 202 and/or the third model 212 are also trained during the training.

The output variables of the models are, for example, summarized in vectors. For example, a trajectory or the controller parameters in the scenario is/are described by a vector that is output by the third model 212.

For example, the map is described by a vector that is output by the third model 212, which vector comprises the parameters of the formal language in which the map is described.

The first model 202, the second model 208, and/or the third model 212 can be a stochastic, probabilistic model or a deterministic model.

The first model 202, the second model 208, and the third model 212 in one example are designed to map in the reverse direction. Mapping in the reverse direction makes interpretability of behavior possible because the models are correlated with language. This means that the third model 212 is designed to map the output variable 214 of the third model 212 onto the output variable 210 of the second model 108. The second model 208 is designed to map the output variable 210 of the second model 208 onto the output variable 206 of the first model 202. The first model 202 is designed to map the output variable 206 of the first model 202 onto the input variable 204 of the first model 202.

For mapping in the reverse direction, it may be provided that images of a video are used one after the other for the output variable 214 of the third model 212, wherein the video is mapped onto a textual description of the content of the video. This means that the matching textual description is generated from a behavior video.

A method for explaining a behavior of the second agent, in particular in the interaction with the first agent, provides that the output variable 214 of the third model 212 comprises the behavior to be explained.

The method for explaining provides that the output variable 214 of the third model 212 is mapped onto the output variable 210 of the second model 108.

The method for explaining provides that the output variable 210 of the second model 208 is mapped onto the output variable 206 of the first model 202.

The method for explaining provides that the output variable 206 of the first model 202 is mapped onto the input variable 204 of the first model 202. The input variable 204 of the first model 202 comprises the description of the behavior to be explained, in particular of the interaction to be explained between the first agent and the second agent.

1-12. (canceled)

13. A method for generating for a first agent an interaction between the first agent and a second agent, the method comprising:
mapping a description of a behavior of the first agent in the interaction between the first agent and the second agent, onto a first representation using a first model, the first model being configured to map the description onto the first representation;
mapping the first representation onto a second representation using a second model, the second model being configured to map the first representation onto the second representation;
mapping, using a third model, the second representation onto an output variable for influencing the behavior of the first agent, the third model being configured to map the second representation onto the output variable;
wherein the description is specified: in natural language including text form or audio form, or in formal language or in digital graphic form;
wherein the behavior of the first agent in the interaction between the first agent and the second agent is specified depending on the output variable.

14. The method according to claim 13, wherein an anomaly in the behavior of the second agent in the interaction between the first agent and the second agent is recognized depending on the interaction.

15. The method according to claim 13, wherein: (i) the output variable includes a trajectory of the first agent and/or (ii) the output variable includes controller parameters for a controller of the first agent, and the behavior of the first agent is determined depending on a behavior of the controller in the first agent.

16. The method according to claim 13, wherein the first model includes a pre-trained artificial neural network and/or the second model includes a pre-trained artificial neural network and/or that the third model includes a pre-trained artificial neural network.

17. A method for training at least one model for generating for a first agent an interaction between the first agent and a second agent, the method comprising:
mapping a description of a behavior of the first agent in an interaction between the first agent and the second agent, onto a first representation using a first model, the first model being configured to map the description onto the first representation;
mapping the first representation onto a second representation using a second model, which is designed to map the first representation onto the second representation;
mapping, using a third model, the second representation onto an output variable for influencing the behavior of the first agent, the third model being configured to map the second representation onto the output variable;,
wherein the description is specified: in natural language or in formal language or in digital graphic form;
wherein the description and a reference for the output variable are specified, and
wherein the reference characterizes a behavior of the first agent that is realistic in the real world and matches the description, and wherein the second model is trained depending on a difference between the output variable and the reference.

18. The method according to claim 17, wherein the first model includes a pre-trained artificial neural network and/or the third model includes a pre-trained artificial neural network.

19. The method according to claim 18, wherein the first model and/or the third model remain unchanged during training.

20. The method according to claim 17, wherein the reference includes a trajectory of the first agent and/or controller parameters for a controller of the first agent.

21. A device for generating interactions or for training at least one model or for training a first agent for an interaction between the first agent and a second agent, the device comprising:
at least one processor; and
at least one memory;
wherein the at least one processor is configured to execute instructions that, when executed by the at least one processor, cause the device to generate an interaction between the first agent and a second agent, including:
mapping a description of a behavior of the first agent in the interaction between the first agent and the second agent, onto a first representation using a first model, the first model being configured to map the description onto the first representation,
mapping the first representation onto a second representation using a second model, the second model being configured to map the first representation onto the second representation,
mapping, using a third model, the second representation onto an output variable for influencing the behavior of the first agent, the third model being configured to map the second representation onto the output variable,
wherein the description is specified: in natural language including text form or audio form, or in formal language or in digital graphic form,
wherein the behavior of the first agent in the interaction between the first agent and the second agent is specified depending on the output variable;
wherein the at least one memory stores the instructions.

22. A data structure, comprising:
at least one data field for a description of a behavior of a first agent in an interaction between the first agent and a second agent, in natural language or in formal language;
at least one data field for a first representation of the description;
at least one data field for a second representation of the description; and
at least one data field for an output variable for influencing the behavior of the first agent.

23. The data structure according to claim 22, further comprising:
at least one data field for a first model, which is configured to map the description onto the first representation; and/or
at least one data field for a second model, which is configured to map the first representation onto the second representation, and/or
at least one data field for a third model, which is configured to map the second representation onto the output variable.

24. A non-transitory computer-readable medium on which is stored a computer program including instructions for generating for a first agent an interaction between the first agent and a second agent, the instructions, when executed by a computer, causing the computer to perform the following steps:
mapping a description of a behavior of the first agent in the interaction between the first agent and the second agent, onto a first representation using a first model, the first model being configured to map the description onto the first representation;
mapping the first representation onto a second representation using a second model, the second model being configured to map the first representation onto the second representation;
mapping, using a third model, the second representation onto an output variable for influencing the behavior of the first agent, the third model being configured to map the second representation onto the output variable;
wherein the description is specified: in natural language including text form or audio form, or in formal language or in digital graphic form;
wherein the behavior of the first agent in the interaction between the first agent and the second agent is specified depending on the output variable.
